(19) United States
(12) Patent Application Publication
(10) Pub. No.: US 2024/0073546 A1
(43) Pub. Date: Feb. 29, 2024

(54) CAMERA SYSTEM FOR HOME AND VEHICLE SECURITY

(71) Applicants: Rodney Adams, Glendale, AZ (US); Aaliyah A. Adams, Glendale, AZ (US)

(72) Inventors: Rodney Adams, Glendale, AZ (US); Aaliyah A. Adams, Glendale, AZ (US)

(21) Appl. No.: 18/144,279

(22) Filed: May 8, 2023

Related U.S. Application Data
(60) Provisional application No. 63/402,519, filed on Aug. 31, 2022.

(51) Int. Cl. H04N 23/90; G08B 13/196; G08B 25/10; H04M 1/72409; H04N 7/18; H04N 23/661

(52) U.S. Cl. CPC H04N 23/90; G08B 13/19645; G08B 25/10; H04M 1/72409; H04N 7/181; H04N 7/188; H04N 23/661; H04M 2201/40

(57) ABSTRACT

An improved camera system designed and adapted to improve home and vehicle security. The system incorporates a plurality of small cameras electronically connected to and controlled by a central processor and are adapted to take pictures individually or all at once. The cameras are design to be difficult to see and are positioned at various points on a home or vehicle to offer full viewing coverage there around. The central processor may also be connected to and communicate with an external computer system via wireless interfaces.

### CROSS-REFERENCE TO RELATED APPLICATION

The present application is related to and claims priority from prior provisional application Ser. No. 63/402,519, filed Aug. 31, 2022 which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to home and vehicle security systems, and more specifically to camera systems for home and vehicle security systems.

### 2. Description of the Related Art

Prior home and vehicle security systems incorporate large cameras that are easily visible and not aesthetically pleasing. As such, nefarious actors are able to maneuver around and/or even hide from these cameras. Furthermore, prior home and vehicle security systems incorporating cameras are designed to retrieve video at all times and are not defaulted for taking still images. Therefore, locating images on the prior home and vehicle security system files to determine the identity of nefarious actors or circumstances leading up to unwanted incidents are extremely time consuming and difficult. Thus, a need exists for an improved home and vehicle security system to avoid the above-mentioned problems.

### BRIEF SUMMARY OF THE INVENTION

In view of the foregoing disadvantages inherent in the known types of home and vehicle security systems or the like in the prior art, the present invention provides a novel camera system for home and vehicle security systems. As such, the general purpose of the present invention, which will be described subsequently in greater detail, is to provide an improved camera system designed and adapted to improve home and vehicle security. The system incorporates a plurality of small cameras electronically connected to and controlled by a central processor and are adapted to take pictures individually or all at once. The cameras are design to be difficult to see and are positioned at various points on a home or vehicle to offer full viewing coverage there around. The central processor may also be connected to and communicate with an external computer system via wireless interfaces.

There has thus been outlined, rather broadly, the more important features of the invention in order that the detailed description thereof that follows may be better understood and in order that the present contribution to the art may be better appreciated. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an improved camera system for home and vehicle security, constructed and operative according to the teachings of the present invention.

FIG. 1 shows a top view illustrating a vehicle incorporating the improved camera system for home and vehicle security according to the preferred embodiment of the present invention.

FIG. 2 shows a perspective view illustrating the vehicle incorporating the improved camera system for home and vehicle security according to the preferred embodiment of FIG. 1.

FIG. 3 shows a perspective view illustrating a home incorporating the improved camera system for home and vehicle security according to the preferred embodiment of the present invention.

FIG. 4 shows a perspective view illustrating central processor formed as a smart phone according to the preferred embodiment of the present invention.

The various embodiments of the present invention will hereinafter be described in conjunction with the appended drawings.

### DETAILED DESCRIPTION

As discussed above, embodiments of the present invention relate to an improved camera system for home and vehicle security. The system incorporates a plurality of small cameras electronically connected to and controlled by a central processor and are adapted to take pictures individually or all at once. The cameras are design to be difficult to see and are positioned at various points on a home or vehicle to offer full viewing coverage there around. The central processor may also be connected to and communicate with an external computer system via wireless interfaces.

The instant invention offers 24 hour video recording, 24 hour motion sensor, and 24 hour voice command to your home and car cameras from your smartphone/tablet/computer. GPS, night vision, videos, and pictures can be sent to your smartphone, and law enforcement and fire departments will have access to the cameras to view all crimes. The cameras can be installed on all homes, businesses, newer cars, older cars, and trucks. The instant invention can solve and/or slow down crimes, road rage, school shootings, drug trafficking, kidnappings, rapes, and home invasions. If every home, business, car, and truck in the world had the instant invention installed therein, the world would become a safer and better place for all. The instant invention is adapted to send alerts to a smartphone if a motion is detected, and offers the ability to speak to your home or car or businesses 24 hours a day through your smartphone, computer, or tablet, and the ability to send crime videos and photos of criminals in the act if they are seen on the camera feeds, and can be sent through text messages or emails from a smartphone to communicate directly with law enforcement to provide video and photographic proof for law enforcement.

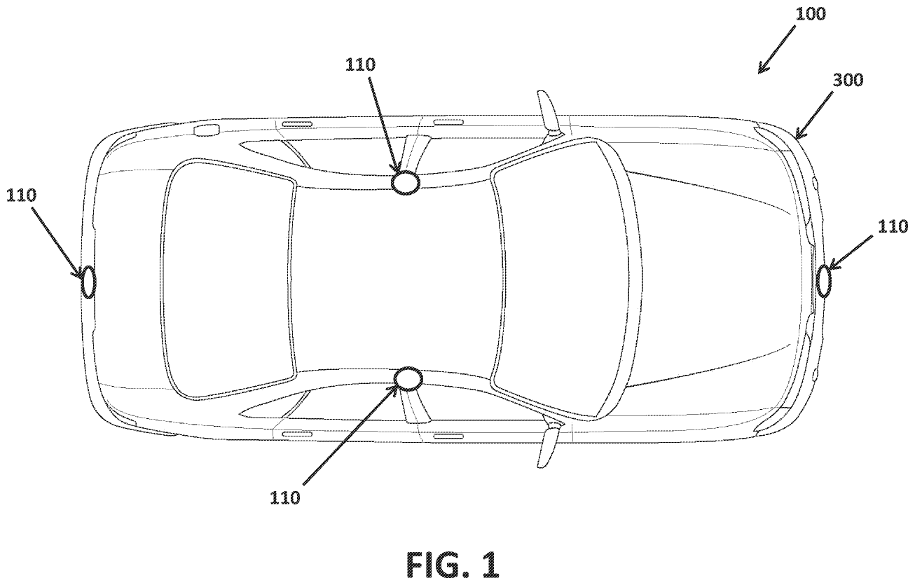

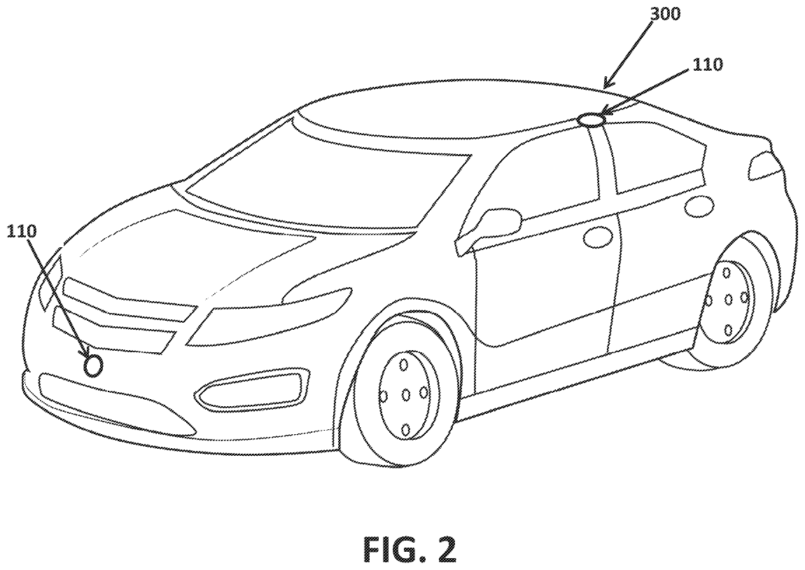

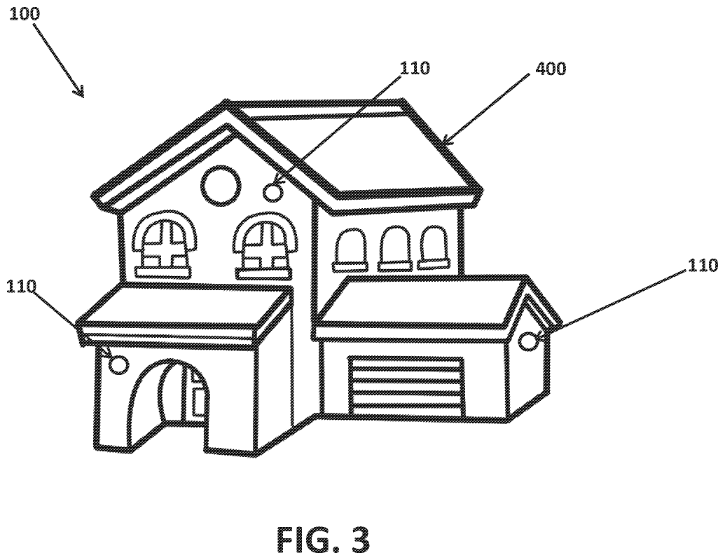

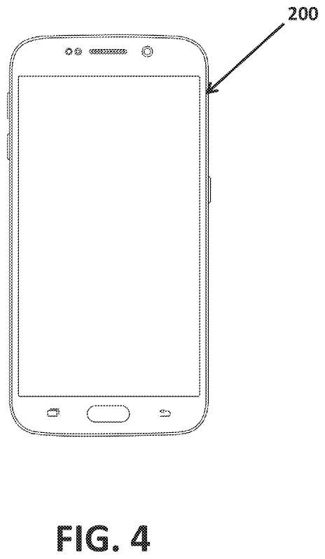

Referring now to the drawings FIGS. 1-4, the improved camera system for home and vehicle security 100 comprising a plurality of small cameras 110 placed upon a vehicle 300 or a home 400. As shown in FIG. 1, four cameras 110 are placed at strategic locations around the body of the vehicle 300, usually the front, back, and sides. As such, a full 360 degree view of the area surrounding the vehicle is visible to the cameras. As shown in FIG. 3, cameras 110 can also be placed at strategic locations around the outer surface of the home 400. Each camera 110 is equipped with a transceiver to electronically communicate with a central processor 300, which can be formed as a smart phone incorporating a computer application designed and adapted to control each camera. Using wireless technology, the central processor 300 is adapted to provide a user the ability to push a button to take a picture from any camera or all of them at the same time. The computer application is also adapted to provide the user the ability to program the application to take pictures at predetermined times from any camera or all of them at the same time. Each camera 110 is also equipped with a motion sensor adapted to sense motion and automatically initiate picture taking when motion is sensed and send images of the object in motion electronically to the central processor. Furthermore, the central processor 300 is adapted to provide a user the ability to control the cameras 110 and take pictures using voice commands through a microphone thereof. The cameras 110 of the instant invention can also be equipped with speakers to allow an audio message to be played when motion is detected, such as “You are now being recorded”.

The improved camera system for home and vehicle security 100 can also be used while a driver is driving a vehicle, wherein a driver can control and operate the cameras 110 using voice commands and perform picture snap capture functions, and send and receive information, including images, with an external computer system using wireless and internet technologies.

The improved camera system for home and vehicle security 100 can also be used in conjunction with smart televisions and appliances, wherein picture snap capture functions and visual displays can be performed therethrough, and wherein controls and operations thereof can be performed via voice commands.

Further features of the improved camera system for home and vehicle security 100 include allowing the police or fire department access to the cameras 110 via the central processor 300, or a direct feed to the transceivers of the cameras 110.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

What is claimed is:

1. An improved camera system for home and vehicle security, comprising:
a plurality of cameras, wherein each said camera includes:
a transceiver;
wherein said transceiver is adapted to electronically communicate with a central processor;
wherein said plurality of cameras are adapted to be placed at pre-chosen locations around the body of the home or vehicle;
a central processor including:
a transceiver;
wherein said transceiver is adapted to electronically communicate with said plurality of cameras; and
a computer application;
wherein said computer application is encoded upon said central processor and is adapted to
wherein said central processor is adapted to control each of said plurality of cameras;
wherein said plurality of cameras are adapted to be positioned at various locations on a home or vehicle to offer full viewing coverage there around to a user.

2. The improved camera system for home and vehicle security of claim 1, wherein said central processor is formed as a smart phone.

3. The improved camera system for home and vehicle security of claim 1, wherein said central processor is adapted to provide said user the ability to program the application to take pictures at predetermined times from any one of or all of said plurality of cameras at the same time.

4. The improved camera system for home and vehicle security of claim 1, wherein each said plurality of cameras includes a motion sensor adapted to sense motion and automatically initiate picture taking when motion is detected, and send images of the object in motion electronically to said central processor.

5. The improved camera system for home and vehicle security of claim 1, wherein said central processor further includes a microphone and is adapted to provide said user the ability to control said plurality of cameras to take pictures using voice commands via said microphone.

6. The improved camera system for home and vehicle security claim 5, wherein said user can control said plurality of cameras to take pictures using voice commands via said microphone while operating a vehicle.

7. The improved camera system for home and vehicle security claim 6, wherein said user can control said central processor via voice commands to send and receive information, including images, with an external computer system using wireless and internet technologies.

8. The improved camera system for home and vehicle security of claim 5, wherein said plurality of cameras are adapted to be integrated with smart televisions and home appliances, such that picture taking functions and visual displays can be performed through said smart televisions and home appliances, and wherein controls and operations thereof can be performed via voice commands.

9. The improved camera system for home and vehicle security of claim 1, wherein said central processor is adapted to allow police and fire department access to said plurality of cameras via said central processor.
